(19) United States
(12) Patent Application Publication
(10) Pub. No.: US 2019/0077634 A1
(43) Pub. Date: Mar. 14, 2019

(54) BELT AND SHEAVE ARRANGEMENT WITH LINEAR GUIDANCE FOR AN ELEVATOR

(71) Applicant: Inventio AG, Hergiswil (CH)

(72) Inventors: Ajay Narendar R.V., Pune (IN); Rohit Raj, Brahmpura, Bihar (IN)

(21) Appl. No.: 16/090,292

(22) PCT Filed: Apr. 3, 2017
(86) PCT No.: PCT/EP2017/057853

§ 371 Date: Oct. 1, 2018

(30) Foreign Application Priority Data
Apr. 4, 2016 (EP) 16163712.9

(51) Int. Cl. B66B 7/06; B66B 15/04

(52) U.S. Cl. CPC B66B 7/062; B66B 15/04

(57) ABSTRACT

An elevator belt includes elongate load carrying members and a jacket with a straight line of recesses parallel to an extension direction of the belt at a center of the jacket. The recesses extend at least to a depth between two neighboring members and can be slits throughout the jacket. The recesses have lateral flanks arranged at an angle of more than 60° to an extension plane of the belt. A sheave has a main body with a cylindrical traction surface and a sprocket arranged coaxial with and at a center of the traction surface with respect to a longitudinal extension of the traction surface. Teeth of the sprocket extend outwardly beyond the traction surface. A bearing connects the sprocket rotatably to the main body. The teeth engage and cooperate with the recesses or slits to prevent any lateral slippage or jumping of the belt on the traction surface.

### FIELD

The present invention relates to a belt of a suspension traction means for an elevator. Furthermore, the invention relates to a sheave to be applied in an elevator. Finally, the invention relates to an elevator comprising such belt and sheave.

### BACKGROUND

Elevators generally comprise an elevator car in which passengers or goods may be transported. In a common type of an elevator, the elevator car is suspended to a suspension traction means (STM—sometimes also referred to as suspension traction media). Such suspension traction means typically comprises one or more ropes or belts. The STM may be displaced using a sheave acting as a traction sheave driven by a motor such that the elevator car suspended thereby is for example vertically displaced throughout an elevator shaft. Furthermore, one or more sheaves acting as pulleys may be applied in the elevator in order to e.g. suspend the elevator car and/or a counterweight.

In modern elevators, elongate belts are generally used as STMs. Such elongate belts have a width being substantially larger than their height, i.e. their cross section is not round but e.g. rectangular. Typically, a belt comprises a plurality of elongate load carrying members such as wires, bundles of wires, fibers, compounds of fibers or ropes or similar. These load carrying members may be made with a material and/or a structure being highly resistant against pull loads such as to enable a high load bearing capacity for the STM. For example, the load carrying members may be made with metal wires, particularly with steel wires, or ropes comprising a plurality of such wires. Alternatively or additionally, the load carrying members may be made with fibers such as Kevlar fibers, aramid fibers, carbon fibers, etc. or bundles or ropes comprising such fibers. The load carrying members are generally arranged in parallel to each other and along a longitudinal extension direction of the belt.

Furthermore, the belt generally comprises a jacket enclosing the plurality of load carrying members. In other words, the load carrying members are generally embedded into a matrix material forming a jacket. Therein, the matrix material is preferably an elastic material such as an elastomer. On the one hand, such jacket may protect the load carrying members against for example mechanical abrasion and/or corrosive attacks. On the other hand, such jacket may provide for an increased friction and smooth cooperation between the belt and a traction sheave or a pulley.

In an elevator, a belt being the STM or forming a part of the STM is typically fixed to a load bearing structure within the elevator shaft. Furthermore, the belt is connected to for example the elevator car and/or the counterweight such as to carry their weight. In order to be able to displace the elevator car and/or the counterweight within the elevator shaft, the STM may be suspended to and cooperate with traction sheaves and/or pulleys. Such sheaves may for example be rotatably attached to load bearing structures within the elevator shaft or to the elevator car and/or the counterweight. Furthermore, a traction sheave may be rotatably attached and driven by a motor such as to form an engine driving the STM.

It may be noted that the term “sheave” shall be interpreted herein in a broad manner and shall relate to both, traction sheaves and pulleys, or other rotatable structures being adapted to cooperate with and potentially guide a belt of an STM within an elevator system.

In conventional elevators, it has been observed that during operation of the elevator including displacing the STM relative to one or more sheaves, problems may occur due to a belt of an STM displacing relative to a sheave in a direction parallel to the rotation axis of the sheave. In other words, under specific circumstances, the belt may laterally slip along the circumferential surface of the sheave in a direction parallel to the rotation axis of the sheave. Such lateral slippage of the belt with respect to the sheave may occur for example when the rotation axis of the sheave is not exactly orthogonal to the longitudinal displacement direction of the belt.

In order to prevent or at least reduce such lateral slippage of the belt with respect to the sheave, belts and sheaves have conventionally been provided with a surface texture including grooves within the jacket of the belt and grooves within a cylindrical traction surface of the sheave. However, it has been observed that even such countermeasures may not always reliably prevent the described lateral slippage between belt and sheave.

As an additional measure to prevent or at least detect lateral slippage, WO 2014/001371 A1 describes an elevator system including a monitoring device allowing determining a lateral slippage of a belt-like support means from a car deflection pulley.

There may be a need for an alternative approach for reducing or preventing lateral slippage of a belt with respect to a sheave in an elevator.

### SUMMARY

According to a first aspect of the invention, a belt of a suspension traction means for an elevator is described. The belt comprises a plurality of elongate load carrying members and a jacket enclosing the plurality of load carrying members. The load carrying members are arranged in parallel to each other along an extension direction of the belt. The jacket is provided with one or more recesses being arranged along a straight line parallel to the extension direction of the belt at a center of the jacket. The one or more recesses have a deep depth extending at least down to a level between two neighboring load carrying members. Furthermore, the one or more recesses have lateral flanks being arranged at more than 60°, preferably more than 70° or 80° or being substantially rectangular, to an extension plane of the belt.

According to a second aspect of the invention, a sheave for guiding a suspension traction means for an elevator is proposed. The sheave comprises a main body and a sprocket. The main body is provided with a cylindrical traction surface. The sprocket is arranged coaxial with the cylindrical traction surface and is arranged at a center of the cylindrical traction surface with respect to a longitudinal extension of the cylindrical traction surface.

One or more teeth of the sprocket extend outwardly beyond the cylindrical traction surface. Furthermore, the sprocket is connected to the main body via a bearing such as to be rotatable relative to the main body.

According to a third aspect, an elevator arrangement is proposed. The elevator arrangement comprises a belt according to an embodiment of the above first aspect of the invention and a sheave according to an embodiment of the above second aspect of the invention.

Ideas underlying embodiments of the present invention may be interpreted as being based, inter alia and without restricting the scope of the invention, on the following observations and recognitions.

In order to enable more efficient guidance of a belt when running along a traction surface of a sheave, it is proposed to provide the belt with a jacket having a specific geometry. Particularly, the jacket shall include one or preferably several recesses or slit-like through-holes being arranged along a straight line extending in a same direction as the extension direction of the belt. Therein, the straight line formed by the recess(es) shall extend at a center of the jacket, i.e. apart from lateral borders of the jacket. It may be noted that such center may be but does not necessarily have to be a geometrical middle of the belt measured along a width direction of the belt.

The one or more recesses shall have a depth which shall be substantially deeper than for example a depth of grooves forming a surface texture of conventional belts. The depth of the recess(es) is therefore referred herein as “deep depth”. Particularly, such recess(es) with such deep depth shall extend from a surface of the jacket significantly down into a core of the jacket down to a region where the load carrying members are embedded within the jacket. Accordingly, the recess(s) shall extend at least down to a level between two neighboring load carrying members. Typically, the deep depth of the recess(s) may be at least 20%, preferably at least 50% or, as will be described below, 100%, of a thickness of the jacket.

Accordingly, when a tooth of the sprocket of the proposed sheave engages into a recess in the jacket of the belt, such tooth may stabilize the belt's position in a lateral direction with respect to the cylindrical traction surface of the main body of the sheave. In other words, the tooth or teeth of the sprocket engaging with the recess(s) of the belt may help aligning the belt with respect to the sheave and therefore may help preventing any lateral slippage of the belt with respect to the sheave.

Preferably, the recess(es) extend only along a single straight line or a few straight lines, i.e. there are no plural straight lines extending parallel to the extension direction of the belt along which recesses are arranged. In other words, while there is one or a few straight lines at which recesses with a deep depth extend at least down to a level between two neighboring load carrying members, there are also portions in the jacket in which no recesses with such deep depth are provided between two neighboring load carrying members.

In order to enable an efficient force transmission between the belt and the sprocket of the sheave, the recess(s) shall be provided with lateral flanks being very steep, i.e. being arranged at more than 70° or, preferably, being substantially rectangular, to an extension plane of the belt. Such steep flanks at the recess(s) may interact with lateral flanks of the sprocket and its teeth engaging into the recess(s) such that guiding lateral forces may be efficiently transmitted between the sprocket of the sheave and the belt via the flanks of the sprocket's teeth abutting to the flanks of the belt's recess(s).

Furthermore, according to an embodiment, the tooth or teeth of the sprocket may have lateral flanks arranged at more than 60°, preferably more than 70° or 80° or being substantially rectangular, with respect to a rotation axis of the sprocket.

In other words, the tooth or teeth of the sprocket shall have a steep lateral flank, preferably at both sides thereof. These flanks preferably extend in a plane orthogonal to the rotation axis of the sprocket, however at least with an angle of less than 30° to such plane, i.e. at an angle of more than 60° to the rotation axis.

Accordingly, the steep flanks of the teeth of the sprocket may engage and abut to the steep flanks of the recesses in the belt thereby enabling efficient lateral force transmissions between these two components. The lateral forces transmitted thereby may help aligning and prevent lateral slippage of the belt with respect to the sheave.

However, in an elevator comprising the proposed belt and the proposed sheave, it may be advantageous or even necessary that some longitudinal slippage between the belt and the sheave is still be possible. In other words, while lateral slippage between the belt and the sheave shall be prevented as efficiently as possible in order to avoid substantial misalignment between the belt and the sheave, longitudinal slippage between the belt and the sheave should still be possible.

Such longitudinal slippage may be for example important when the proposed sheave is the traction sheave driven by the engine of the elevator. In such case, a certain longitudinal slippage between the driven traction sheave and the belt interacting with its traction surface should be enabled in order to for example avoid excessive accelerations being transmitted from the traction sheave to the belt. Such excessive accelerations could otherwise for example occur upon an emergency braking of the moving belt induced by rapidly stopping the traction sheave.

In order to enable such longitudinal slippage, the sprocket of the sheave shall not be fixedly connected to the main body of the sheave. Instead, a bearing shall be provided for connecting the sprocket to the main body in such manner such as to enable rotation of the sprocket relative to the main body. Accordingly, due to such bearing, the sprocket may rotate freely and independently of any rotating motion of the main body of the sheave.

Thus, while one or more teeth of the sprocket may engage with recesses within the belt, the sprocket may freely rotate and may therefore not hinder any longitudinal slippage of the belt with respect to the main body of the sheave but only hinders lateral slippage.

According to an embodiment, the jacket of the belt shall be provided with a plurality of recesses being periodically arranged along the straight line extending at the center of the jacket.

In other words, preferably, not only a single recess is provided in the jacket but a multiplicity of recesses shall be provided serially along the straight line extending at the center of the jacket. Therein, the recesses shall be arranged periodically. For example, all recesses may have a same geometry and may be arranged at same longitudinal distances to each other. Alternatively, the recesses may have various geometries, particularly various lengths measured in the longitudinal direction, and/or may be arranged at various distances to each other along the longitudinal direction, but the variation of the geometry and/or the distances should be periodical.

Similarly, according to an embodiment, the sprocket of the sheave may comprise a plurality of teeth being arranged periodically along an outer circumference of the sprocket. Again, several teeth having a same geometry may be arranged at equal distances along the circumference of the sprocket. Alternatively, the geometry and/or the distances between the teeth may vary.

Specifically, according to an embodiment, the teeth of the sprocket of the sheave may be adapted to engage with the recesses in the belt. For such purpose, a geometry and/or size of the tooth or teeth of the sprocket and a geometry and/or size of the recess(es) in the belt may be chosen such that the tooth or teeth may fit into and/or engage with the recess(es) in the belt.

For example, the tooth or teeth of the sprocket may have a geometry being complementary to a geometry of the recesses in the belt. Alternatively, the tooth or teeth of the sprocket may be smaller, particularly may be shorter in longitudinal extension, than the recesses in the belt.

Particularly, the periodicity of the recesses in the belt and the periodicity of the teeth at the sprocket of the sheave may be synchronized with each other. Accordingly, when the belt runs along the cylindrical traction surface of the sheave, the teeth of the sprocket of the sheave may synchronously engage with the recesses of the jacket of the belt.

Specifically, according to an embodiment, a width of the teeth of the sprocket in a direction parallel to the longitudinal extension of the cylindrical traction surface substantially corresponds to a width of the recess(es) in the belt in a direction rectangular to the extension direction of the belt. In other words, the width of a tooth of the sprocket may be same or only slightly smaller than the width of a recess in the belt to be engaged by the tooth. Accordingly, the lateral flanks of the tooth may abut against the lateral flanks of the recess. Thereby, efficient lateral force transmission between the tooth and the recess may be established.

According to an embodiment, the tooth or teeth of the sprocket may be tapered in an outwards direction.

For example, a tooth may be tapered such as to have a broader width at its base and a smaller width at its tip. Such tapered tooth may easily engage into a recess of a belt. The recess in the belt may be tapered in a similar fashion, i.e. may have a broader width close to a surface of the jacket and a smaller width deep in the core of the jacket. Accordingly, the taperings of the tooth and of the recess may preferably be complementary. With tapered teeth and/or tapered recesses, an engagement between the sprocket of the sheave and the jacket of the belt may be simplified and alignment of both components with respect to each other may be enhanced.

According to an embodiment, a length of the tooth or teeth of the sprocket in a direction parallel to the circumference of the cylindrical traction surface is same or shorter than a length of the recesses in the belt in the extension direction of the belt.

In other words, while width dimensions of the teeth and the recesses may preferably be complementary to each other in order to support lateral force transmission between the sprocket and the belt, length dimensions of the teeth of the sprocket, on the one hand, and the recesses of the belt, on the other hand, may be similar, i.e. complementary, or, alternatively, they may significantly differ in that the length of the teeth is for example substantially shorter than the length of the recesses. With such short length of the teeth, each tooth may easily engage into one of the recesses within the belt. Upon such engagement, longitudinal alignment between the teeth and the recesses is not critical. Particularly, it may be allowable or even preferable that a tooth engaging into a recess of the belt may be displaced in a longitudinal direction within the recess. Accordingly, some longitudinal slippage between the belt and the sheave may occur wherein the tooth of the sprocket may linearly and longitudinally move along the recess in the belt during such slippage.

According to a specific embodiment of the belt, the one or more recesses may be provided with a deep depth which varies along the extension direction of the belt.

In other words, preferable, there is no single recess extending throughout the entire longitudinal length of the jacket with a constant depth. Instead, this recess may have a depth which varies along the longitudinal extension of the recess. For example, the recess may have regions which go deeper into the jacket and regions which are shallower. At least in the regions going deeper into the jacket, the recess may have the deep depth extending at least down to the level between two neighboring load carrying members.

In an alternative variant or in an extreme interpretation of such varying depth, there may be multiple recesses arranged serially behind each other along the straight line at the center of the jacket. Such variant could also be interpreted as representing a single recess having portions with a significant depth and having other portions having a zero depth.

Furthermore, also within the separate recesses or separate portions of the same recess, the depth may locally vary along the length of such recess. For example, a depth of a recess may be deeper in a center of the recess than at longitudinal borders of the recess.

According to a further specified embodiment, the one or more recesses are provided as slits at least locally extending through an entire thickness of the jacket.

In other words, in such embodiment, the recesses are not only depressed regions within the jacket but are through-holes throughout the entire jacket thereby forming elongate slits through the jacket.

Particularly in such embodiment, the belt may be interpreted as representing a combination of a conventional belt and a chain. While portions of the belt adjacent to the recesses act in a same manner as in a conventional belt, the slits along the center of the jacket may be formed as a middle strip of the belt which may mate with the sprocket provided at the sheave.

Therein, the slits or slots in the jacket of the belt may be for example punched into the jacket. Alternatively, slits or slots may be prepared already when fabricating the jacket, for example by suitably molding the material forming the jacket.

Expressed more specifically, according to an embodiment, the recesses are provided as a plurality of slits extending along the straight line and being separated from each other in the extension direction of the belt by bridging portions connecting laterally neighboring portions of the belt.

In other words, the belt may be interpreted as comprising at least two laterally neighboring portions, i.e. an elongate left portion and an elongate right portion. Both these portions may be interpreted as being similar to a conventional belt of small width which may be tracked on a traction surface of a sheave in a conventional manner. These two portions of the belt are connected with each other by bridging portions in a mechanically stable manner. The two neighboring elongate portions and the bridging portions preferably extending transversal thereto may be integral, i.e. may form a single device. Therein, the bridging portions may be mainly formed by a part of the jacket whereas each of the elongate load carrying members extends either in the one or in the other laterally neighboring portions but not in the bridging portions. The slits extend in a longitudinal direction between the bridging portions thereby forming through-holes into which the tooth or teeth of the sprocket may engage.

According to an embodiment, the jacket is furthermore provided with a surface texture with grooves in the extension direction of the belt having a shallow depth smaller than the deep depth of the recess(es) and not extending down to a level where the load carrying members are embedded in the jacket.

In other words, while the belt may in principle be provided with a jacket having a smooth or even surface, it may be preferable to provide the jacket with a specific texture in which small grooves extend along the longitudinal direction of the belt. These small grooves may provide for a certain guidance for the belt when cooperating with a traction surface of a sheave, especially when the traction surface is also provided with a corresponding texture. However, such grooves do not go deep into the jacket but are generated only in a surface portion of the jacket.

Thus, contrary to the deep recess(es) provided for interacting with the sprocket of the sheave, the grooves of the surface texture do not extend substantially down to a level between two neighboring load carrying members.

Furthermore, lateral dimensions and depth dimensions of the surface texture are preferably substantially smaller than such dimensions of the recess(es). For example, the width and/or particularly the depth of the recess(es) may be at least 200%, preferably at least 500%, of the width and/or depth, respectively, of the grooves of the surface texture.

For example, such lateral and depth dimensions of the surface texture may be significantly smaller than respective dimensions of the load carrying members embedded in the jacket. In contrast hereto, the recess(es) in the belt may have such dimensions substantially corresponding or being even larger than the dimensions of the load carrying members. Particularly, the depth of the recess(es) may be significantly larger than a dimension of the load carrying member in a direction parallel to such depth direction.

Similarly, according to an embodiment, the main body of the sheave may be furthermore provided with a surface texture with circumferential grooves at its traction surface, the grooves having a depth smaller than a protrusion height with which the tooth or teeth of the sprocket extend beyond the traction surface.

In other words, preferably, such texture at the main body's traction surface may be adapted in size and structure such as to cooperate with an abutting surface of a driven belt in order to provide for some lateral guidance of the belt during its motion along the sheave. Particularly, the surface texture at the sheave's main body and a surface texture at the jacket of the belt may have similar or cooperating or complementary structures and/or dimensions.

However, while the dimensions of the surface texture are relatively small, the tooth or teeth of the sprocket have substantially larger dimensions such that for example the teeth substantially protrude beyond a radially outer limit of the surface of the main body including its surface texture.

As a side note only, it shall be mentioned that even a traction surface of the main body provided with a surface texture shall be interpreted herein as being a “cylindrical” traction surface as its general geometry is “cylindrical”.

It shall be noted that possible features and advantages of embodiments of the invention are described herein partly with respect to a belt, partly with respect to a sheave and partly with respect to an elevator comprising such belt and sheave. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 shows a top view onto a belt according to an embodiment of the present invention.

FIG. 2 shows a cross-sectional view of the belt of FIG. 1 along the line A-A indicated in FIG. 1.

FIG. 3 shows a longitudinal section view of the belt of FIG. 1 along the line B-B indicated in FIG. 1.

FIG. 4 shows a cross-sectional view of a sheave according to an embodiment of the present invention.

FIG. 5 shows a front view onto the sheave of FIG. 4.

FIG. 6 shows a side view (partially cut-away) onto a sheave-belt-arrangement for an elevator according to an embodiment of the present invention.

The figures are only schematically and not to scale. Same reference signs refer to same or similar features throughout the figures.

### DETAILED DESCRIPTION

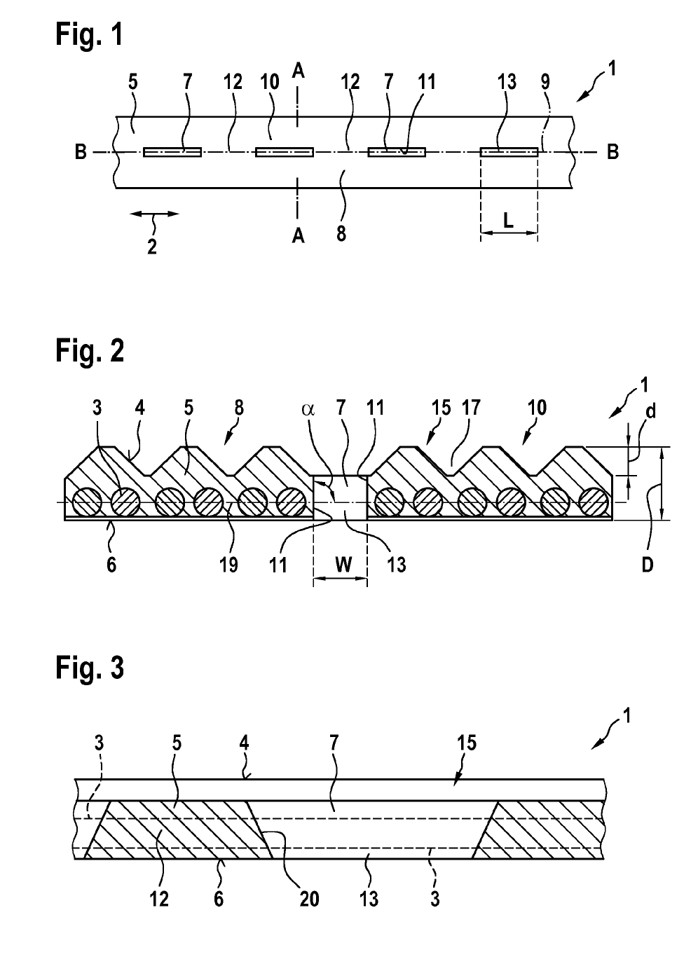

FIGS. 1, 2 and 3 show an embodiment of a belt 1 of a suspension traction means for an elevator in a top view, a cross-sectional view and a longitudinal section view, respectively. The belt 1 comprises a plurality of longitudinal load carrying members 3 and a jacket 5 enclosing these load carrying members 3.

The load carrying members 3 may be wires, strings, cords or similar. The load carrying members 3 may be made with metal or synthetic material such as carbon fibers or similar. The load carrying members 3 may have cross-sectional dimensions in a range from a few millimeters to some centimeters. For example, in a typical case of load carrying members having a circular cross-section, a diameter of a load carrying member may typically be between 1 mm and 5 cm, preferably between 0.5 cm and 3 cm. The load carrying members 3 are arranged along the longitudinal extension direction 2 of the elongate belt 1. Due to the plurality of load carrying members 3, the belt 1 is adapted for carrying significant loads ranging for example from some hundred kg up to some tons such that one or several of such belts 1 may be applied for carrying the weight of for example an elevator car and/or a counterweight within an elevator.

The jacket 5 is typically made from a synthetic material, preferably an elastomeric material. Preferably, the material of the jacket 5 completely encloses the load carrying members 3 such that these load carrying members 3 are embedded in a matrix forming the jacket 5 and are therefore protected by the jacket 5 against, inter alia, mechanical abrasion and/or corrosion.

While many features of the belt 1 such as its outer dimensions, the load carrying members 3 enclosed therein, the type and material of the jacket 5, etc. may be similar or same to those generally applied for conventional belts of suspension traction means in an elevator, the belt 1 described herein differs from such conventional belt in that the jacket 5 comprises one or more recesses 7 being arranged along a straight line 9 extending at a center of the jacket 5 and being parallel to the extension direction 2 of the belt 1. These one or more recesses 7 extend deep into the jacket 5 such that their deep depth D reaches down to a level between two neighboring load carrying members 3. Furthermore, the one or more recesses 7 have lateral flanks 11 being arranged at an angle α of more than 60° with respect to an extension plane 19 of the belt 1.

In the exemplary embodiment shown in FIGS. 1, 2 and 3, the belt 1 comprises a multiplicity of recesses 7. These recesses 7 are arranged periodically along the straight line 9. Particularly, in the example shown, the recesses 7 are arranged equidistantly.

Furthermore, the recesses 7 are provided as slits 13 extending entirely through the jacket 5 from a one surface thereof to an opposite surface thereof. In other words, the recesses 7 are slits or slots having a deep depth D corresponding to a thickness of the belt 1 and therefore extending entirely through the belt 1 and its jacket 5. Accordingly, the slits 13 extend from a contact surface 4 of the belt 1 which, in later application, shall abut to a sheave such as a traction sheave or a pulley down to a level between neighboring load carrying members 3 and further on to an opposite rear surface 6 of the jacket 5.

A width W of the recesses 7 or slits 13 may be in a range from few millimeters to a few centimeters. Preferably, the width W is in a same order of magnitude as cross sectional dimensions of the load carrying members 3.

Furthermore, in the example shown, the lateral flanks 11 of the slits 13 extend rectangular, i.e. α=90°, with respect to the extension plane 19 of the belt 1. Longitudinal flanks 20 may extend in an acute angle of for example less than 70° or even less than 50° such that the recess 7 or slit 13 is tapered, i.e. has a longer length at a region adjacent to the contact surface 4 than in a region adjacent to the rear surface 6 of the jacket 5.

The elongate slits 13 linearly extend along the straight line 9, i.e. in parallel to the extension direction 2 of the belt 1 and therefore also in parallel to the extension direction in which the load carrying members 3 are arranged. Serially neighboring slits 13 are separated from each other in the extension direction 2 of the belt by bridging portions 12 which connect laterally neighboring portions 8, 10 of the belt 1. The bridging portions 12 are preferably integral with the laterally neighboring portions 8, 10 of the belt 1 and may be part of the jacket 5.

The bridging portions 12 may have a same or even longer length in a direction parallel to the extension direction 2 of the belt 1 compared to the length L of the recesses 7 or slits 13. However, it may be preferable to provide the bridging portions 12 with a shorter length than the length of the recesses 7 or slits 13. Furthermore, the bridging portions 12 may have a same or similar thickness as the laterally neighboring portions 8, 10 of the belt 1. Alternatively, the bridging portions 12 may have a smaller thickness than these laterally neighboring portions 8, 10. In principle, the bridging portions 12 may have a relatively short longitudinal length and small thickness as long as a mechanical integrity of the belt 1 is maintained, i.e. as long as the laterally neighboring portions 8, 10 of the belt 1 are connected with each other via the bridging portions 12 in a mechanically stable manner.

As shown particularly in FIG. 2, the exemplary belt 1 furthermore comprises a surface texture 15 at its jacket 5. This surface texture 15 comprises grooves 17 extending in the extension direction 2 of the belt 1. Preferably, the grooves 17 have a V-shaped or U-shaped cross section. These grooves 17 have a shallow depth d which is smaller than the deep depth D of the recesses 7 or slits 13 and does not extend down to the level where the load carrying members 3 are embedded in the jacket 5. Such surface texture 15 may be same or similar as generally used for contact surfaces of conventional belts.

While a specific and preferred exemplary embodiment of a belt 1 is shown in the figures, embodiments of the inventive belt 1 may also be provided with alternative or additional features. For example, the recesses 7 do not necessarily have to reach entirely through the jacket 5 thereby forming slits 13 but instead may only go deep into the jacket 5 but having a deep depth D smaller than the thickness of the belt 1. The depth of the recesses 7 may or may not vary along the extension direction 2 of the belt 1. Furthermore, a steepness of the lateral flanks 11 may vary as long as at least portions of the flanks 11 are sufficiently steep. Also a form and steepness of longitudinal flanks 20 may vary.

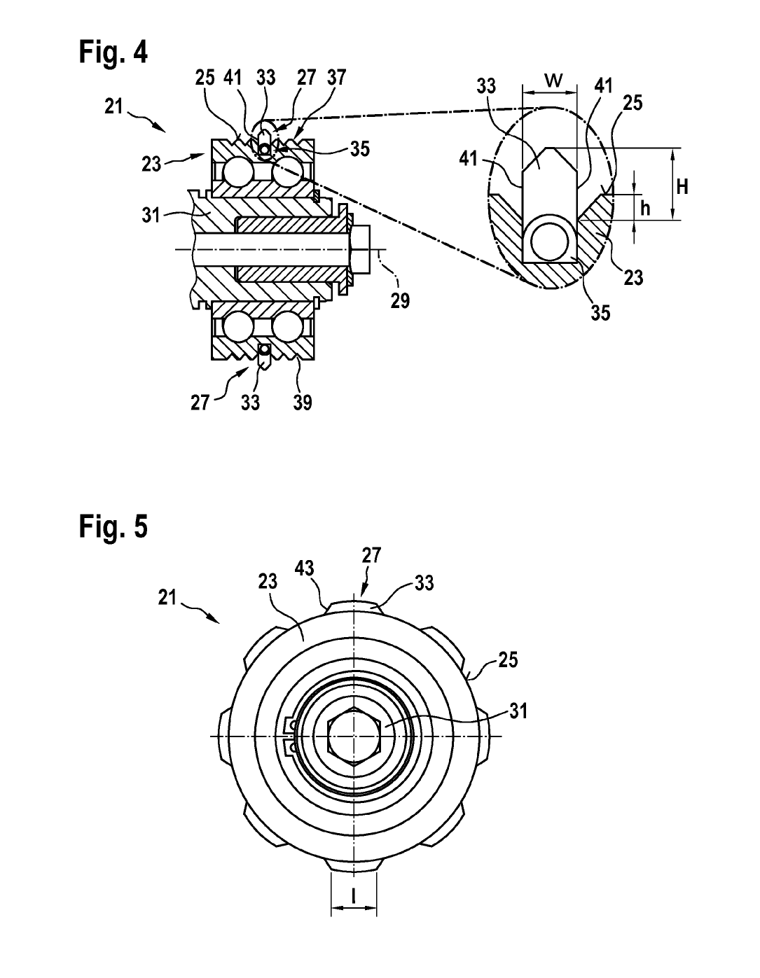

FIGS. 4 and 5 show a cross-sectional view and a front view, respectively, of a sheave 21 for guiding a belt of a suspension traction means for an elevator according to an exemplary embodiment of the present invention.

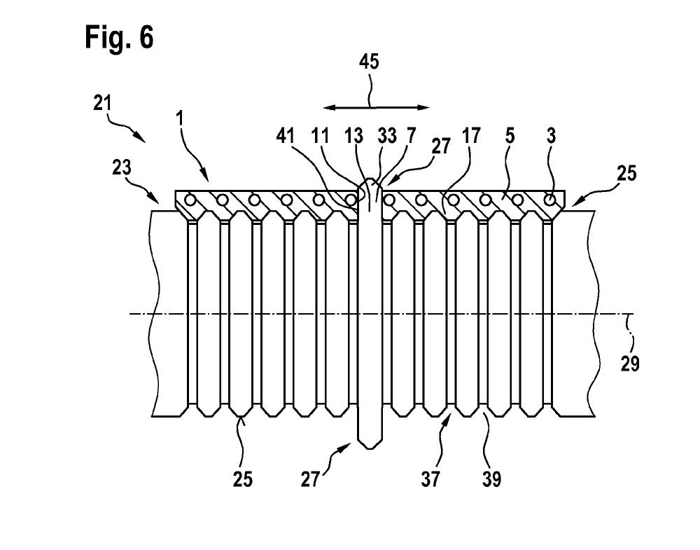

The sheave 21 comprises a main body 23 having a substantially cylindrical traction surface 25. The main body 23 is fixed to a shaft 31 or spindle such as to be rotatable around a rotation axis 29 extending parallel to the longitudinal extension 45 (FIG. 6) of the cylindrical traction surface 25. The main body 23 may be made with a stable and resistant material such as metal, particularly such as steel. The cylindrical traction surface 25 may or may not be provided with a covering protection layer or friction layer.

Furthermore, the sheave 21 comprises a sprocket 27. The sprocket 27 is arranged coaxial with the cylindrical traction surface 25 of the main body 23, i.e. the cylindrical traction surface 25 of the main body 23 and the sprocket 27 may have a common rotational symmetry axis. Furthermore, the sprocket 27 is arranged at a center of the cylindrical traction surface 25 with respect to a longitudinal extension 45 of the cylindrical traction surface 25. Therein, the “center” may or may not be a geometric middle of the cylindrical traction surface 25 but at least is distant to both end faces of the main body 23.

The sprocket 27 comprises at least one tooth but preferably a plurality of teeth 33 extending outwardly beyond the cylindrical traction surface 25. Such tooth or teeth 33 may protrude from the cylindrical traction surface 25 with a protrusion height H. The protrusion height H may be only a few millimeters but, preferably, the protrusion height H is several centimeters. Particularly, the protrusion height H should preferably be dimensioned such as to substantially correspond to or even exceed a deep depth D of recesses 7 in a belt 1 to be guided along the cylindrical traction surface 25 of the sheave 21. A width w of the teeth 33 may be in a range from few millimeters to a few centimeters.

The sprocket 27 is mechanically connected to the main body 23 via a bearing 35 such that the sprocket 27 is rotatable relative to the main body 23. For example, a ball-bearing may be interposed between the main body 23 and the sprocket 27. Accordingly, the sprocket 27 may freely rotate with respect to the main body 23 and its angular orientation may be independent from an angular orientation of the main body 23.

However, while being rotatable with respect to the main body 23 along the rotation axis 29, the sprocket 27 shall be held with respect to the cylindrical traction surface 25 of the main body 23 such as to be kept in a stationary central location with respect to the longitudinal extension of the cylindrical traction surface 25. In other words, the sprocket

27 shall not be able to move relative to the cylindrical traction surface 25 in a direction parallel to the rotation axis 29.

Each tooth of the sprocket 27 has lateral flanks 41 which are preferably arranged at an angle of more than 60°, preferably at a rectangular angle, with respect to the rotation axis 29 of the sheave 21 and of the sprocket 27. Close to a free end of a tooth, the lateral flanks 41 may converge into a pointed tip. In other words, a tip of the teeth 33 may be tapered in a width direction parallel to the longitudinal extension of the cylindrical traction surface 25.

Longitudinal flanks 43 of the teeth 33 may in principle be arranged rectangular to a circumference of the cylindrical traction surface 25. However, it may be preferred to provide the teeth 33 with longitudinal flanks 43 extending in an acute or pointed angle with respect to such circumference such that the teeth 33 of the sprocket 27 are tapered in an outwards direction.

Furthermore, as shown in FIG. 4, the cylindrical traction surface 25 may be provided with a surface texture 37 comprising grooves 39, preferably V-shaped grooves 39, extending in a circumferential direction at the cylindrical traction surface 25. These grooves 39 have a smaller depth h than a protrusion height H with which the teeth 33 of the sprocket 27 extend beyond the traction surface 25. For example, the protrusion height H of the teeth 33 may be at least double, preferably at least 4 times, the depth h of the surface texture's grooves 39.

FIG. 6 shows a combination of a belt 1 according to an embodiment of the first aspect of the invention and a sheave 21 according to an embodiment of the second aspect of the invention.

The teeth 33 of the sprocket 27 of the sheave 21 engage into the recesses 7 or slits 13 in the belt 1. Therein, dimensions of the recesses 7 or slits 13 are adapted such as to enable engaging of the teeth 33 in a complementary manner at least in a lateral direction. In other words, the width W of the recesses 7 or slits 13 and the width w of the teeth 33 of the sprocket 27 shall be substantially same such that the lateral flanks 11 of the recesses 7 or slits 13 may abut to the lateral flanks 41 of the teeth 33 of the sprocket 27. Particularly, an angle of the lateral flanks 11 of the recesses 7 or slits 13, on the one hand, and an angle of the lateral flanks 41 of the teeth 33 of the sprocket 27 should preferably be complementary. Accordingly, the sprocket 27 engaging with its teeth 33 into the recesses 7 or slits 13 of the belt 1 may laterally align and stabilize the belt's 1 position with respect to the longitudinal extension 45 of the cylindrical traction surface 25.

Summarized in an alternative wording, embodiments of the inventive belt 1 and of the inventive sheave 21 may be configured such that the belt 1 may act as a conventional belt in an elevator arrangement but may also act as a kind of chain in which a middle strip of the belt 1 is provided with slots or slits 13 created in the jacket 5 of the belt 1 in order to mate with teeth 33 of a sprocket 27 provided for example in a center of a main body 23 of a car pulley in an elevator. Such chain-sprocket-like arrangement in a car pulley or, alternatively, in a traction sheave of an elevator may eliminate lateral jumps or lateral slippage of the belt 1 out from the sheave 21. Therein, the sprocket 27 may freely rotate with respect to the main body 23 of the sheave 21, i.e. the sprocket 27 does not hinder a longitudinal motion of the belt 1 along the circumference of the sheave 21. However, the sprocket 27 with its teeth 33 may be able to prevent a lateral, i.e. horizontal, movement or displacement of the belt 1, i.e. a movement/displacement of the belt 1 with respect to the sheave 21 along the longitudinal extension 45 of the cylindrical traction surface 25 of the main body 23. A design of the sprocket 27 may bear a necessary pull through force so that the belt 1 may not be allowed to move out of the recesses 7 or slits 13. Accordingly, jumping of the belt 1 may be prevented. The sprocket 27 is fixed to the main body 23 of the sheave 21 through the bearing 35 which may be for example press-fit onto the main body 23. Preferably, a profile of the sprocket 27 and its teeth 33 may be adapted such that any misalignment of the belt 1 with respect to the sheave 21 can also be handled. A length L of the recesses 7 or slits 13 should not be more than a circumferential length l of the sprocket 27.

Finally, it should be noted that the term “comprising” does not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE SIGNS

1 belt
2 extension direction of the belt
3 load carrying members
4 contact surface of jacket
5 jacket
6 rear surface of jacket
7 recess
8 first laterally neighboring portion of belt
9 straight line
10 second laterally neighboring portion of belt
11 lateral flank of recess
12 bridging portion between recesses
13 slit
15 surface texture of belt
17 groove
19 extension plane of belt
20 longitudinal flank of recess
21 sheave
23 main body
25 cylindrical traction surface
27 sprocket
29 rotation axis
31 shaft
33 tooth
35 bearing
37 surface texture of sheave
39 groove
41 lateral flank of tooth
43 longitudinal flank of tooth
45 longitudinal extension of traction surface

1-14. (canceled)

15. A belt of a suspension traction means for an elevator, the belt comprising:
a plurality of elongate load carrying members arranged in parallel to each other along an extension direction of the belt;
a jacket enclosing the load carrying members;
wherein the jacket has a surface texture of a contact surface with grooves in the extension direction of the belt, the grooves each having a first depth that does not extend to a level where the load carrying members are embedded in the jacket;
wherein the jacket has at least one recess in the contact surface being arranged along a straight line parallel to the extension direction of the belt and at a center of the contact surface of the jacket; and
wherein the at least one recess has a second depth extending at least down to a level between two neighboring ones of the load carrying members and the at least one recess has lateral flanks being arranged at an angle of more than 60° to an extension plane of the belt.

16. The belt according to claim 15 wherein the jacket has a plurality of the at least one recess being periodically arranged along the straight line.

17. The belt according to claim 15 wherein the second depth varies along the extension direction of the belt.

18. The belt according to claim 15 wherein the at least one recess is a slit at least locally extending through an entire thickness of the jacket.

19. The belt according to claim 15 wherein the jacket has a plurality of the at least one recess, each of the recesses being a slit extending along the straight line, the slits being separated from each other in the extension direction of the belt by bridging portions of the jacket connecting laterally neighboring portions of the belt.

20. A sheave for guiding a suspension traction means for an elevator, the sheave comprising:
a main body having a cylindrical traction surface;
a sprocket extending outwardly from the traction surface;
wherein the sprocket is arranged coaxial with the traction surface at a center of the traction surface with respect to a longitudinal extension of the traction surface;
wherein the sprocket includes at least one tooth that extends outwardly beyond the traction surface; and
wherein the sprocket is connected to the main body by a bearing such that the sprocket is rotatable relative to the main body.

21. The sheave according to claim 20 wherein the at least one tooth has lateral flanks arranged at more than 60° with respect to a rotation axis of the sprocket.

22. The sheave according to claim 20 wherein the sprocket includes a plurality of the at least one tooth being arranged periodically along an outer circumference of the sprocket.

23. The sheave according to claim 20 wherein the at least one tooth is tapered in an outwards direction.

24. The sheave according to claim 20 wherein the main body has a surface texture with circumferential grooves formed in the traction surface, the grooves each having a depth less than a protrusion height of the at least one tooth beyond the traction surface.

25. An elevator comprising:
a sheave including a main body having a cylindrical traction surface and a sprocket extending outwardly from the traction surface, wherein the sprocket is arranged coaxial with the traction surface at a center of the traction surface with respect to a longitudinal extension of the traction surface, the sprocket including at least one tooth that extends outwardly beyond the traction surface, and the sprocket being connected to the main body by a bearing such that the sprocket is rotatable relative to the main body; and
a belt cooperating with the traction surface of the sheave, the belt including a plurality of elongate load carrying members arranged in parallel to each other along an extension direction of the belt, the belt including a jacket enclosing the load carrying members, the jacket having a surface texture of a contact surface with grooves in the extension direction of the belt, the grooves each having a first depth that does not extend to a level where the load carrying members are embedded in the jacket, the jacket having at least one recess in the contact surface being arranged along a straight line parallel to the extension direction of the belt and at a center of the contact surface of the jacket, the at least one recess cooperating with the at least one tooth, and wherein the at least one recess has a second depth extending at least down to a level between two neighboring ones of the load carrying members and the at least one recess has lateral flanks being arranged at an angle of more than 60° to an extension plane of the belt.

26. The elevator according to claim 25 wherein the at least one tooth of the sprocket is adapted to engage with the at least one recess in the belt.

27. The elevator according to claim 25 wherein a width of the at least one tooth of the sprocket, in a direction parallel to the longitudinal extension of the traction surface, corresponds to a width of the at least one recess in the belt in a direction rectangular to the extension direction of the belt.

28. The elevator according to claim 25 wherein a length of the at least one tooth of the sprocket in a direction parallel to a circumference of the traction surface is equal to or shorter than a length of the at least recess in the belt in the extension direction of the belt.
